(19) United States
(12) Patent Application Publication
(10) Pub. No.: US 2024/0006686 A1
(43) Pub. Date: Jan. 4, 2024

(54) MULTILAYER FILM COMPRISING A LAYER OF AN AQUEOUS GEL FOR COOLING AT LEAST ONE ACCUMULATOR WITHIN A BATTERY MODULE, AND ASSOCIATED MODULE

(71) Applicant: COMMISSARIAT A L'ENERGIE ATOMIQUE ET AUX ENERGIES ALTERNATIVES, Paris (FR)

(72) Inventors: Rémi VINCENT, Grenoble Cedex 09 (FR); Maxime HUBERT, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 18/251,324

(22) PCT Filed: Nov. 2, 2021
(86) PCT No.: PCT/EP2021/080412

§ 371 Date: May 1, 2023

(30) Foreign Application Priority Data
Nov. 2, 2020 (FR) 20 11196

(51) Int. Cl. H01M 10/658; H01M 10/613; H01M 10/643; H01M 50/526; H01M 50/524; H01M 50/213; H01M 10/0525

(52) U.S. Cl. CPC H01M 10/658; H01M 10/613; H01M 10/643; H01M 10/0525; H01M 50/524; H01M 50/213; H01M 50/526

(57) ABSTRACT

A multilayer film may be applied preferably against a busbar of a battery module. Such a multilayer film may include at least one encapsulation layer made of plastic and a layer of aqueous gel, configured to be placed facing at least a portion of the busbar, encapsulated at least partially by the encapsulation layer.

### TECHNICAL FIELD

The present invention relates to the field of electrochemical accumulators, and more particularly to metal-ion accumulators.

More particularly, the invention relates to a multilayer film to be applied against a busbar in a battery module.

It is recalled here that a busbar is a strip (foil) or bar made of electrically conductive material, possibly laminated with one or more electrically insulating materials, and that is fastened, preferably screwed or welded, to an output terminal of at least one electrochemical accumulator in order to create the electrical connection to another electrochemical accumulator of a battery pack or another electrical input/output element.

The main aim of the invention is to optimize the cooling of the accumulators of a battery pack such that the energy of a thermal runaway of a given accumulator within the pack cannot propagate to the other accumulators.

Although described with reference to a lithium-ion accumulator, the invention also applies to any metal-ion electrochemical accumulator, i.e. also to sodium-ion, magnesium-ion, aluminum-ion accumulators, etc., or more generally to any electrochemical accumulator.

A battery pack according to the invention can be on-board or stationary. For example, the fields of electric and hybrid transport and grid-connected storage systems may be envisaged within the context of the invention.

### PRIOR ART

As illustrated schematically in FIGS. 1 and 2, a lithium-ion battery or accumulator usually comprises at least one electrochemical cell consisting of an electrolyte constituent 1 between a positive electrode or cathode 2 and a negative electrode or anode 3, a current collector 4 connected to the cathode 2, a current collector 5 connected to the anode 3 and lastly a packaging 6 designed to contain in a sealtight manner the electrochemical cell while at the same time being passed through by a portion of the current collectors 4, 5.

The architecture of conventional lithium-ion batteries comprises an anode, a cathode and an electrolyte. Several types of conventional architecture geometry are known:
a cylindrical geometry as disclosed in the patent application
a prismatic geometry as disclosed in the U.S. Pat. Nos. 7,348,098 and 7,338,733;
a stacked geometry as disclosed in the patent applications US 2008/060189, US 2008/0057392, and the U.S. Pat. No. 7,335,448.

The electrolyte constituent 1 may be in solid, liquid or gel form. In the latter form, the constituent may comprise a separator made of polymer, of ceramic or of microporous composite impregnated with organic or ionic liquid electrolyte(s), which enables lithium ions to move from the cathode to the anode for charging and vice versa for discharging, this generating current. The electrolyte is generally a mixture of organic solvents, for example carbonates, to which is added a lithium salt, typically LiPF6.

The positive electrode or cathode 2 consists of lithium-cation insertion materials, these generally being composite materials, such as LiFePO₄, LiCoO₂ or LiNi_{0.33}Mn_{0.33}Co_{0.33}O₂.

The negative electrode or anode 3 very often consists of carbon graphite or of Li₄TiO₅O₁₂ (titanate material), possibly also based on silicon or a composite formed on a silicon basis.

The current collector 4 connected to the positive electrode is generally made of aluminum.

The current collector 5 connected to the negative electrode is generally made of copper, of nickel-plated copper or of aluminum.

A lithium-ion battery or accumulator may of course comprise a plurality of electrochemical cells stacked on top of one another.

Traditionally, an Li-ion battery or accumulator employs a pair of materials at the anode and at the cathode that enable it to operate at a high voltage level, typically equal to 3.6 volts.

Depending on the type of application targeted, the aim is to produce either a thin and flexible lithium-ion accumulator or a rigid accumulator: the packaging is then either flexible or rigid and, in the latter case, forms a kind of casing.

Flexible packagings are usually made from a multilayer composite material, consisting of a stack of aluminum layers covered by one or more polymer film(s) laminated via adhesive bonding.

Rigid packagings, for their part, are used when the targeted applications impose constraints and where a long service life is sought, with for example much higher pressures to be withstood and a stricter required level of sealtightness, typically of less than 10⁻⁸ mbar·l/s, or in sectors with heavy constraints, such as the aeronautical or space field.

Thus, a rigid packaging used at present consists of a metal casing, typically made of stainless steel (316L stainless steel or 304 stainless steel) or of aluminum (Al 1050 or Al 3003), or else of titanium.

The geometry of most rigid casings for Li-ion accumulator packagings is cylindrical since the majority of electrochemical cells of accumulators are wound in a cylindrical geometry around a cylindrical mandrel by winding. Prismatic forms of casings have also already been produced by winding around a prismatic mandrel.

Patent application FR3004292 describes the use of the inside of the mandrel as an air gap to cool the core of a wound cell of a metal-ion accumulator.

One of the types of cylindrical rigid casing, usually produced for a high-capacity Li-ion accumulator, is illustrated in FIG. 3.

A prismatic rigid housing is also shown in FIG. 4.

The casing 6 comprises a cylindrical lateral jacket 7, a base 8 at one end, a cover 9 at the other end, the base 8 and the cover 9 being attached to the jacket 7. The cover 9 supports the poles or output terminals for the current 4, 5. One of the output terminals (poles), for example the negative terminal 5, is welded to the cover 9, whereas the other output terminal, for example the positive terminal 4, passes through the cover 9 with the interposition of a seal, not shown, that electrically isolates the positive terminal 4 from the cover.

The type of widely produced rigid casing also consists of a deep-drawn cup and a cover that are welded to one another at their periphery. In contrast, the current collectors comprise a passage with a part projecting above the casing and that forms a terminal, also known as exposed pole, of the battery.

A battery pack P consists of a variable number of accumulators, which may reach several thousand, that are connected electrically in series or in parallel with one another and generally by connection bars, commonly called busbars.

One example of a battery pack P is shown in FIG. 5. This pack consists of two modules M1, M2 of Li-ion accumulators A that are identical and connected to one another in series, each module M1, M2 consisting of four rows of accumulators connected in parallel, each row consisting of a number equal to six Li-ion accumulators.

As shown, two Li-ion accumulators on one and the same row are connected mechanically and electrically through the screwing of busbars B1, advantageously made of copper, each connecting a positive terminal 4 to a negative terminal 5. Two rows of accumulators are connected in parallel within one and the same module M1 or M2 by a busbar B2, also advantageously made of copper. The two modules M1, M2 are connected by a busbar B3, also advantageously made of copper.

In the development and the production of lithium-ion batteries, for each profile/new request, regardless of the players on the market, this requires precise dimensioning (series/parallel electrical, mechanical, thermal, etc. architectures) in order to optimally design a high-performance and safe battery pack.

In particular, it is necessary to take into consideration the safety of lithium-ion accumulators simultaneously at the level of a single accumulator, of a module and of a battery pack.

Various passive or active devices having a safety function may also be integrated into a cell (accumulator) and/or a module and/or the battery pack in order to prevent problems, when the battery is in what are called improper operating conditions.

A lithium electrochemical system, whether at the level of the cell (accumulator), the module or the pack, produces exothermic reactions regardless of the given cycling profile. Thus, on the level of a single accumulator, depending on the chemistries under consideration, optimum operation of lithium-ion accumulators is limited to within a certain temperature range.

An electrochemical accumulator has to operate in a defined temperature range, typically generally less than 70° C. on its outer casing surface, otherwise its performance degrades, or it is even physically degraded as far as being destroyed.

Mention may be made for example of iron-phosphate chemistry lithium accumulators, which have an operating range generally between −20° C. and +60° C. Beyond 60° C., the materials may undergo significant degradation, reducing the performance of the cell. Beyond what is called a thermal runaway temperature, which may be between 70° C. and 110° C., exothermic internal chemical reactions are triggered. When the accumulator is no longer capable of removing enough heat, the temperature of the cell increases until it is destroyed, this phenomenon usually being called thermal runaway.

In other words, thermal runaway occurs in a cell (accumulator) when the energy released by the exothermic reactions occurring inside said cell exceeds the capacity to dissipate it to the outside. This runaway may be followed by a generation of gas and an explosion and/or fire.

In addition, maintaining a temperature of below 70° C. makes it possible to increase the service life of an accumulator, since the higher the operating temperature of an accumulator, the shorter its service life will be.

Furthermore, some accumulator chemistries require an operating temperature well beyond ambient temperature, and it therefore proves necessary to regulate their temperature level by initially preheating the accumulators, or even to keep the accumulators at a constant temperature.

At the level of a cell (accumulator), the various known internal protection devices are:
a device with a positive temperature coefficient (PTC, Polymeric positive Temperature Coefficient): these currently equip a large number of cylindrical accumulators already on the market. Such a device is in the form of a polymer (polyethylene) ring laminated with a metal.

In the event of an overload, this polymer heats up, changes phase, becomes more resistive and thus limits the passage of current;
a current interrupt device (CID): this interrupts the current if the gas pressure in the cell exceeds the specified limits;
a circuit breaker (shutdown) device which prevents the generation of high currents;
a vent consisting of a valve or a rupture disk, which opens when the pressure increases suddenly, and exceeds a determined critical pressure, in order to prevent the cell from exploding;
a thermal fuse, currently employed in high-capacity accumulators, which cuts the current when the temperature in the accumulator becomes too high.

In a battery, or battery pack containing a plurality of Li-ion accumulators, placing more or less different accumulators in series or parallel may have consequences on the resulting performance of the pack.

It is thus recognized that, in a battery pack, for example of an electric vehicle, ageing dispersions may be high depending for example on the position of the accumulators, following ageing asymmetries between the accumulators or differences in use (thermal variations between the centre and the edges of the pack, current gradient, etc.).

Therefore, in order to limit premature ageing of the pack, it is necessary to optimize the operating temperature and the temperature dispersion from one accumulator to another. An accumulator (or accumulators) that age(s) faster than the others may have a direct impact on the electrical performance of the whole battery pack. This is manifested in the reduction in the total usable capacity of the battery pack.

At the level of the module and of the pack, typically below 0° C. for example, it may be necessary to use a battery management system (BMS) in order to limit the power requested from the pack and avoid degrading the accumulator batteries in particular in the case of charging the battery.

It is recalled here that the BMS (acronym for “battery management system”) is used in order to protect the elements from factors that increase the danger thereof, such as excessively high currents, unsuitable (excessively high or low) potentials and limit temperatures. The BMS therefore stops the applications of current (charging, discharging) as soon as threshold voltages are reached.

Beyond an upper temperature, typically of the order of 70° C., it is also necessary to be vigilant, since electrochemical reactions may lead to the destruction of the single accumulator batteries and lead to propagation of a fault internal to the accumulator, typically an internal short circuit, which may at worst lead to the pack exploding.

Thus, the inventors have been able to demonstrate, within the context of a study of failure modes, their effects and their criticality, that one of the most critical risks for a battery module and more generally for an Li-ion battery pack was the internal short circuit of a cell, following a manufacturing defect, with a failure rate typically of 10⁻⁷/h.

In this case, it is also necessary to use the BMS in order to protect the accumulators.

The difficulty lies in ensuring temperature uniformity within a battery pack.

Consequently, these thermal considerations generally necessitate regulation of the temperature of the accumulators of a battery pack.

Various thermal management strategies are proposed for optimizing integrated cooling systems and allowing the battery pack to operate at a target ambient temperature and ensure cell temperature homogeneity. The thermal management system must therefore be able to react, and very precisely, if a temperature gradient is observed in the cells constituting it.

In the literature, the solutions disclosed for attempting to ensure temperature homogeneity within a battery pack can be essentially classified into three categories.

The first category concerns the use of cold plates.

U.S. Pat. No. 8,609,268 thus discloses a cold plate system within which a refrigerant fluid flows for draining heat from accumulators in contact with the cold plate.

Patent application WO2011/013997 proposes cooling fins arranged inside a stack of flat cells for draining heat from the cells to a fluid flowing at the bottom of the stack.

The second category concerns cooling via a phase change material.

In patent application DE102013017396A1, the boiling heat transfer liquid is directly in contact with the cells in the battery module, in order to control the temperature and keep it within a predetermined temperature range.

The third category concerns solutions where a (gaseous or liquid) heat transfer fluid is circulated within a battery pack.

U.S. Pat. No. 5,320,190 thus proposes an air circulation for cooling a vehicle battery pack, either directly using the air impacting the vehicle while driving, or using a fan for stationary phases or just after driving.

Patent CN202259596U proposes a battery pack that incorporates air distributors.

Patent application WO2012/165781 proposes a system of air guidance plates that makes it possible a priori to reduce the temperature difference between battery modules.

A cooling liquid may be used instead of air. Indeed, the concepts of cost, bulk and additional mass may be decisive factors depending on the application under consideration.

For example, air cooling is the least burdensome solution since, as indicated, it consists of the forced blowing of air between the accumulators. On the other hand, the thermal performance of air cooling is poor due to the low exchange coefficient and the low thermal inertia. Thus, in this type of cooling, the first accumulator will, in spite of everything, heat up on contact with air, and the air temperature will increase. On passing to the second accumulator, the air is hotter and the accumulator is hotter than the first one. Ultimately, this can therefore result in accumulators the temperature of which is inhomogeneous or the cooling of which is insufficient to limit the risk of runaway.

Liquid cooling solutions are therefore far more effective in terms of heat exchanges: they consist in direct cooling by thermal conduction using a liquid, preferably a dielectric liquid. For example, patent applications WO2008/156737 and US2013196184 propose a system of channels which each conform to part of the periphery of a plurality of cylindrical accumulators in parallel with one another. A heat transfer liquid flows within these channels in order to drain heat.

U.S. Pat. No. 8,877,366 relates to a cooling solution using liquid flowing through external tubes that cool fins, inserted between accumulators, through thermal conduction.

Patent FR3010834 discloses a thermal regulation device for a battery pack, comprising a tube heat exchanger in contact with the accumulators at the base of the housing (jacket) of the battery pack.

The company Mersen has proposed a battery pack with busbars on which pipes with several bends are attached and welded, water, preferably a glycol-water mixture, circulating inside these pipes during operation of the battery pack for the purpose of cooling. Reference may be made to [1].

As explained in this publication, the pipes are intended to eliminate the hot spots in the pack during operation.

Reference may also be made to patent application EP3293786, which describes a similar cooling plate system.

As mentioned above, a cell or an accumulator of the battery pack may undergo a thermal runaway.

However, all of the cooling devices according to the prior art do not really make it possible to mitigate a thermal runaway of an accumulator within a battery pack, that is to say make it possible to attenuate the transmission of the energy dissipated by a thermal runaway of the accumulator to the other accumulators of the pack, in order to prevent them from themselves entering a thermal runaway situation.

There is therefore a need to improve battery-pack cooling solutions, in particular in order to absorb the energy dissipated by a thermal runaway of a given accumulator within the pack and thus to limit the temperature of the other accumulators of the pack and thereby prevent these other accumulators from also going into thermal runaway.

In addition, the improvement should also be optimized in terms of weight and bulk in order to conserve the performance qualities of the pack.

The aim of the invention is to at least partly meet this need/these needs.

### DESCRIPTION OF THE INVENTION

To this end, the invention relates, in one of its aspects, to a multilayer film, to be applied in a battery module (M), preferably against a busbar of the battery module (M), comprising at least one encapsulation layer made of plastic and a layer of aqueous gel, to be placed on the path of the hot gases released by an accumulator of the module (M) during a thermal runaway, preferably facing at least a portion of the busbar, encapsulated at least partially by the encapsulation layer.

The multilayer film can be configured to enable the passage of the hot gases during the release thereof and to form a thermal barrier between the hot gases that have passed through and the accumulators of the module (M) The multilayer film can be traversable only for gases at a pressure and/or a temperature that is/are at least equal to the pressure and/or the temperature of the hot gases during their release.

The encapsulation layer made of plastic can be configured to hold the layer of aqueous gel, to prevent it from drying out and to allow the hot gases to pass through the multilayer film only during their outgassing out of the accumulator in thermal runaway.

The gel layer may be a continuous or discontinuous layer over the length of the film.

The term “length” is understood to mean a dimension of the film transverse to its thickness, which may therefore also be a surface depending on the shape of the zone(s) for the passage of the hot gases and/or the busbars which can be two-dimensional plates. In other words, the gel layer according to the invention can be implemented over the entire film or have an interruption in thickness at at least one point of the film.

According to an advantageous embodiment, the gel layer comprises one or more regions of increased thickness over the length of the film.

According to this embodiment, the region or regions of increased thickness is/are preferably intended to be arranged facing the zone or zones of the module determined beforehand with the greatest risk of heat accumulation and/or close to the contacts between the busbar and the accumulators of the module and/or zones for the passage of the vent gases of the module.

Advantageously, the gel layer is printed, in particular by additive manufacturing, directly on the encapsulation layer.

According to a first variant embodiment, the film comprises two encapsulation layers, one of which is intended to be applied directly against the busbar.

In this configuration, the encapsulation layer that is intended to be applied directly against the busbar is adhesive on its external face.

According to a second variant embodiment, the film comprises a single encapsulation layer, the layer of aqueous gel being intended to be applied directly against the busbar, preferably printed, in particular by additive manufacturing on the busbar.

Advantageously, the encapsulation layer(s) is/are made of a polymer selected from polyethylene (PE) or polyether.

The thickness of each encapsulation layer is preferably at most equal to 50 μm.

The aqueous gel preferably comprises at least 90% deionized water and a gelation polymer having a high degree of polymerization.

The gelation polymer is advantageously selected from methylcellulose, carboxymethylcellulose, polyurethanes, galactan or sodium polyacrylates.

The thickness of the gel layer is preferably at most equal to 10 mm.

According to another variant embodiment, the encapsulation layer made of plastic, intended to be facing at least a portion of the busbar, comprises rupture initiators precut into said layer or cutouts leaving the gel layer exposed from the outside of the film.

A subject of the invention is also a battery module comprising:
a plurality of accumulators of prismatic geometry each comprising at least one electrochemical cell C formed of a cathode, an anode and an electrolyte interposed between the cathode and the anode, and a casing designed to contain in a sealtight manner the electrochemical cell and two output terminals projecting from the cover and/or from the base of the casing;
preferably at least one busbar fastened to one of the output terminals of at least some of the accumulators, in order to connect electrically them to one another;
at least one multilayer film as described above, the layer of aqueous gel being placed in at least one zone intended for the passage of the hot gases released by one of the accumulators during a thermal runaway, preferably at least a portion of the multilayer film being applied against the busbar.

The zone or zones for the passage of the hot gases released during a thermal runaway of one of the accumulators of the module (M) is/are determined beforehand.

During a thermal runaway, the multilayer film can advantageously make it possible to separate the hot gases outgassing out of the triggering accumulator from the rest of the accumulators by forming a thermal barrier that limits the heat exchanges between the vent gases that have passed through the multilayer film and the accumulators.

The hot gases can pass through the multilayer film by penetrating the gel layer and/or the encapsulation layer.

At least one of the accumulators, preferably each accumulator, may comprise at least one safety vent configured to release the pressurized hot gases during a thermal runaway of said accumulator, the gel layer being placed facing the safety vent. Advantageously, such an arrangement makes it possible to increase the amount of hot gases that can pass through the multilayer film during their outgassing. Advantageously, the multilayer film is arranged as closely as possible to the safety vent.

Preferably, the safety vent(s) is/are located on one of the output terminals of the accumulator(s), preferably on the positive output terminal. The outgassing of the hot gases may take place through the busbar.

Preferably, the gel layer faces at least a portion of the busbar.

According to an advantageous embodiment, the gel layer of the film comprises one or more regions of increased thickness over the length of the film, the region or regions of increased thickness preferably being arranged facing the zone or zones of the module determined beforehand with the greatest risk of heat accumulation and/or close to the contacts between the busbar and the accumulators of the module and/or zones for the passage of the vent gases of the module.

According to an advantageous variant embodiment, the gel layer is printed, in particular by additive manufacturing, directly on the busbar.

Thus, the invention essentially consists in a multilayer film, arranged on the path, determined beforehand, of the hot gases released under pressure in the event of thermal runaway of one of the accumulators of a battery module, of which the layer of aqueous gel facing the accumulators will limit the propagation of a thermal runaway from one thereof to the others.

Preferentially, the invention consists in a multilayer film applied against, preferably adhesively bonded against, a busbar of a battery accumulator module, of which the layer of aqueous gel facing the accumulators will limit the propagation of a thermal runaway from one thereof to the others.

Thus, during the thermal runaway of one of the accumulators, which may be denoted as “triggering accumulator”, the evaporation of the water contained in the gel will make it possible to greatly limit the increase in the temperature of the neighboring accumulators.

The aqueous gel as such has only very little action on limiting the thermal runaway of the triggering accumulator within the module. It may have a cooling action, but its primary function is to form a genuine barrier for the thermal protection of the other accumulators, i.e. those which are not undergoing runaway, by preventing the hot gases released by the safety vent(s) of the triggering accumulator from very greatly heating the other accumulators.

The encapsulation layer(s) made of plastic of the multilayer film can help maintain the gel on the busbar and thus prevent it from evaporating and flowing into the module.

It is specified here that for the phenomenon of thermal runaway, reference will be made to publication [2] and to the protocol described in this publication. The so-called “self-heating” and “thermal runaway” temperatures are denoted T1 and T2 respectively in this publication. The temperature T1, typically 70° C., in FIG. 2 of the publication, is the temperature starting from which the accumulator heats up without an external source at a typical rate of 0.02° C./min under adiabatic conditions.

The temperature T2, typically 150° C., in FIG. 2 of the publication, is the temperature starting from which the accumulator heats up at a typical heating rate of 10° C./min under adiabatic conditions, which leads to the melting of the separator in the electrochemical bundle of the accumulator, to a short circuit and therefore to voltage collapse.

The term “thermal runaway” can therefore be understood, here and within the context of the invention, to mean a ratio between the value of the derivative of the heating temperature and that of time, at least equal to 0.02° C. per min.

In other words, by virtue of the gel layer in accordance with the invention, the energy of the thermal runaway of the triggering accumulator is not transmitted in full to the adjacent accumulators of the pack, thus limiting their temperature.

Consequently, a multilayer film according to the invention makes it possible to prevent the neighboring accumulators of a triggering accumulator from also going into thermal runaway. In a preferred embodiment, it is determined beforehand, for a given battery module, the zone or zones of the module which present the greatest risk of heat accumulation and one or more regions of increased thicknesses of the gel layer are produced over the length of the film which, once the film has been applied, will face these zones. The region or regions of increased thickness may also be arranged facing and/or close to the contacts between the busbar and the accumulators of the module and/or zones for the passage of the vent gases of the module.

In other words, the thickness of the film can be variable over its length, with one or more regions of increased thickness at least of the gel layer being located according to the most critical thermal zones of a battery module for which the film is intended to be implemented. In comparison with a known solution using liquid water, the implementation of an aqueous gel according to the invention is simpler. This is because it does not require having a perfectly sealtight container throughout the runaway of an accumulator. The aqueous gel also makes it possible to limit the potential risks of short-circuit within a battery module.

Lastly, the invention affords many advantages, among which mention may be made of:
an easy-to-implement and effective safety solution for preventing the propagation of a thermal runaway within a module or battery pack;
a solution which is not to the detriment of the weight of a module or of a battery pack, since a multilayer film according to the invention can be very light, which is highly advantageous for on-board applications;
the possibility of installing a multilayer film very quickly and easily in a module or battery pack, starting from its conception or, in contrast, as a retrofit of an existing module or battery pack.

For application to an Li-ion battery pack, each accumulator is an Li-ion accumulator in which:
the material of the negative electrode(s) is selected from the group comprising graphite, lithium and the titanate oxide Li₄TiO₅O₁₂;
the material of the positive electrode(s) is selected from the group comprising LiFePO₄, LiCoO₂ and LiNi_{0.33}Mn_{0.33}Co_{0.33}O₂.

Other advantages and features of the invention will become more clearly apparent on reading the detailed description of examples of implementation of the invention, which description is non-limiting and given by way of illustration, with reference to the following figures.

### BRIEF DESCRIPTION OF THE DRAWINGS

FIG. 1 is a schematic exploded perspective view showing the various elements of a lithium-ion accumulator.

FIG. 2 is a front view showing a lithium-ion accumulator with its flexible packaging according to the prior art.

FIG. 3 is a perspective view of a lithium-ion accumulator according to the prior art with its rigid packaging consisting of a cylindrical casing.

FIG. 4 is a perspective view of a lithium-ion accumulator according to the prior art with its rigid packaging consisting of a prismatic casing.

FIG. 5 is a perspective view of an assembly using busbars of lithium-ion accumulators according to the prior art, forming a battery pack.

FIG. 6 is a side view of a battery module equipped with a busbar against which is applied an example of a multilayer film according to the invention.

FIG. 7 is a view of a module similar to FIG. 6, equipped with its casing, FIG. 7 showing a thermal runaway situation of one of the accumulators of the module.

FIG. 7A FIG. 7A is a detail view of FIG. 7.

FIG. 8 is a photographic reproduction of an experimental set-up of an assembly of two Li-ion accumulators with a busbar which connects them electrically on which a multilayer film according to the invention.

FIG. 9 illustrates, in the form of curves, the temperature readings taken with the experimental set-up, with and without a layer of aqueous gel of a film according to the invention.

FIG. 10 is a side view of a battery module equipped with its casing and a busbar against which is applied an example of a multilayer film according to a variant of the invention.

### DETAILED DESCRIPTION

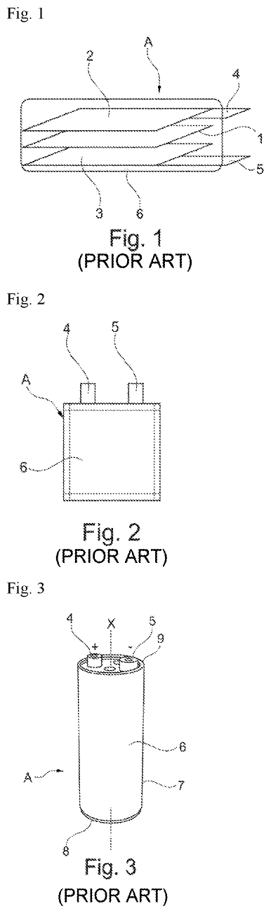

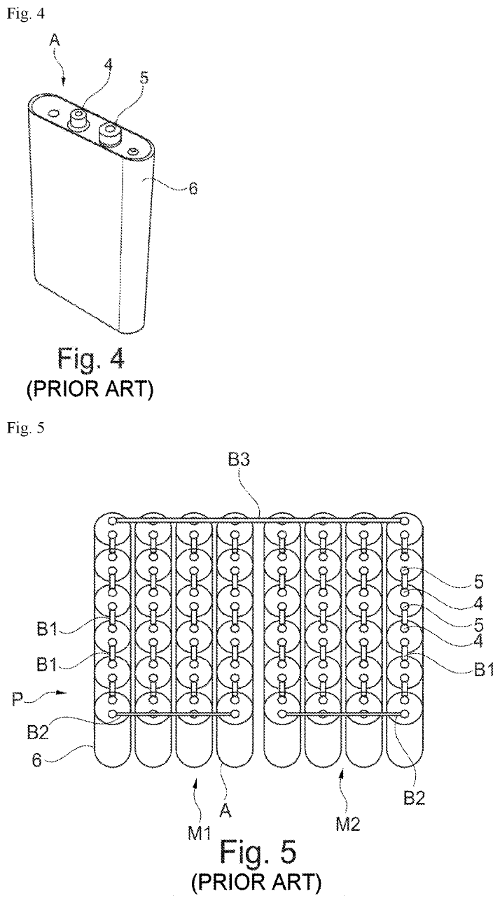

FIGS. 1 to 5 relate to various examples of Li-ion accumulator, flexible packagings and casings of accumulators and also a battery pack according to the prior art. These FIGS. 1 to 5 have already been commented on in the preamble and are therefore not commented on further below.

For the sake of clarity, the same references denoting the same elements according to the prior art and according to the invention are used for all of FIGS. 1 to 10.

Throughout the present application, the terms “lower”, “upper”, “bottom”, “top”, “below” and “above” are to be understood with reference to Li-ion accumulator casings arranged vertically, that is to say with a multilayer film according to the invention being horizontal.

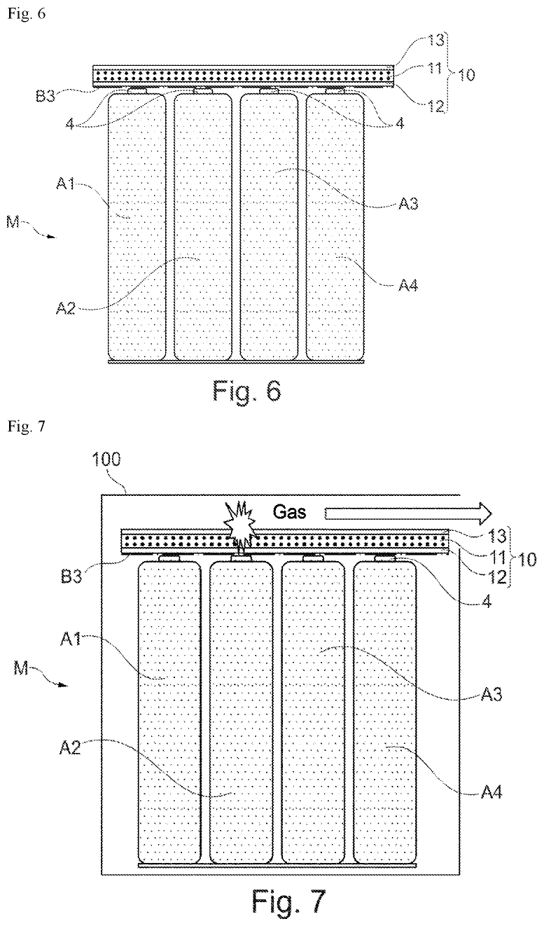

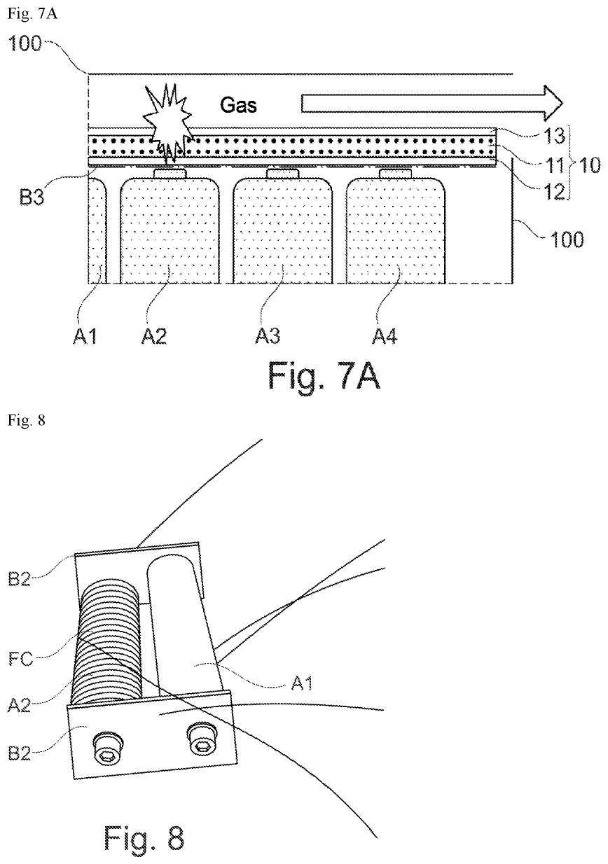

FIGS. 6, 7 and 7A show a first example of a multilayer film 10 according to the invention applied against a busbar B3 of a battery module M of Li-ion accumulators, A1, A2, A3, A4.

In the examples illustrated, the illustrated accumulators A1-A4 may have cylindrical format casings, typically of 18650 or 21700 format.

The accumulators A1-A4 are electrically connected by their output terminal, by group, by the busbar B3.

According to the invention a multilayer film 10 according to the invention is applied, preferably adhesively bonded, directly against the busbar B3.

This film 10 consists of a layer 11 of aqueous gel, comprising at least 90% water, encapsulated preferably by heat sealing between two encapsulation layers 12, 13 made of polymer, preferably of polyethylene (PE) or of polyether.

The thickness of each encapsulation layer 12, 13 is typically approximately 50 μm.

The aqueous gel preferably comprises at least 90% deionized water and a gelation polymer having a high degree of polymerization (which may range up to several million). For example, polyethylene glycol with a degree of polymerization of 5 million can be diluted in water with a ratio of 4%. Polymers such as methylcellulose, carboxymethylcellulose, polyurethanes, galactan or sodium polyacrylates may also be used.

For certain configurations, for example with a busbar arranged vertically, it may be advantageous to provide a gel having a viscosity which increases with temperature. In this case, preference may be given to methylcellulose as gelling agent.

The thickness of the gel layer 11 may be approximately 10 mm.

The production of an aqueous gel according to the invention is effected by slowly dissolving the polymers in water at 50° C. A commercial mixer is used for stirring at 2000 rpm, in order to achieve good homogenization of the gel.

As concerns the installation of a multilayer film 10 according to the invention within a battery module M, this may be carried out in several steps. A first step consists in placing a chosen plastic film 12 on the busbar B3 of the positive terminals 4.

The aqueous gel 10 is then deposited by screen printing either continuously or intermittently at critical locations.

Lastly, the encapsulation of the layer of aqueous gel 11 is carried out by heat sealing after the deposition of a second film 13 on top of the gel.

During the thermal runaway of an 18650 format accumulator, approximately 80 kJ of thermal energy can be released.

Generally, the energy released is shared between the gases and the ejected molten materials, which represent approximately 70% of the heat, and the energy emitted by the casing of the accumulator due to the materials retained in the construction of the accumulator, which represents the remaining 30% of the heat.

It is therefore important to implement a solution for mitigating the transfer of heat between the accumulators, taking into consideration the thermal convection via the gases and also the conduction via the busbars.

As shown schematically in FIGS. 7 and 7A, the addition of an aqueous gel on a busbar, typically connected to the positive terminals 4 of accumulators A1-A4, makes it possible to limit these two modes of heat transfer. The hot gases from the triggering accumulator, in this case the accumulator A2, are evacuated via the safety vent thereof.

In the embodiments illustrated, the safety vent of the accumulator A2 is located on its positive terminal 4. The hot gases evacuated via the safety vent then pass through the busbar B3, and then pass through the multilayer film 10.

The aqueous gel then limits conduction via the busbar B3 as well as the effect of thermal convection of the hot gases on the adjacent accumulators A1, A3 and A4. 30 grams of liquid water need to be evaporated to absorb 80 kJ of thermal energy. However, given the high proportion of heat which leaves with the gases during the runaway of an accumulator A, a mass of 25 g of water for a number of 9 accumulators arranged three-by-three in a square already makes it possible to limit the propagation.

FIG. 8 illustrates an experimental setup for proving the effectiveness of a layer of aqueous gel according to the invention. Two accumulators A1, A2 are realized by two aluminum rods which have a thermal behavior close to the conventional casings in Li-ion accumulators.

The triggering accumulator A2 is surrounded by a copper heating wire (FC) to simulate the rise in temperature during a thermal runaway.

The second accumulator A1 is connected to the first by busbars B1, B2, respectively at the top and at the bottom, in the form of metal foils fastened to the two output terminals 4, 5.

Here, the aqueous gel is deposited vertically on the two foils. The sufficient viscosity of the gel means that it can be maintained in this orientation.

The test consists of measuring the temperature on the triggering accumulator A2 as well as on the foils B1, B2 and at two locations on the accumulator A1.

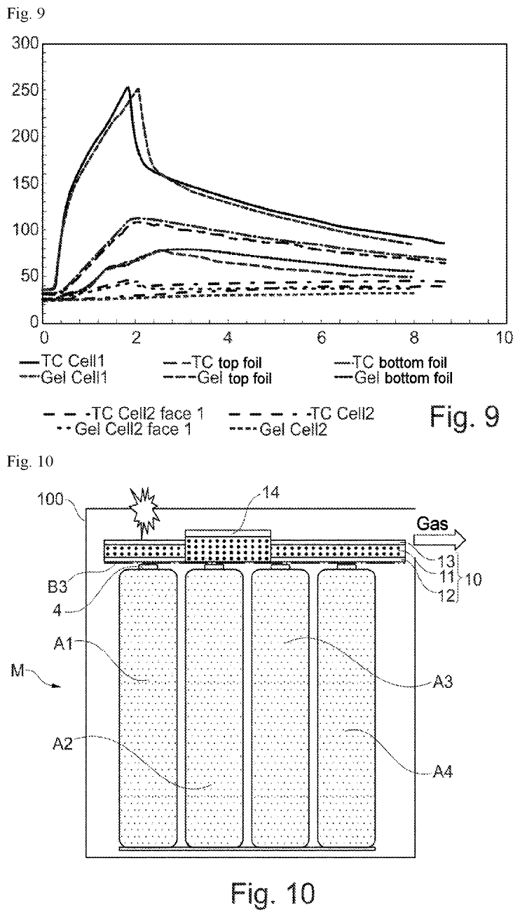

The result of the temperature measurements for the test without the aqueous gel (solid lines) and with the aqueous gel (dotted lines) is shown in FIG. 9.

It can be seen in this FIG. 9 that the heating is the same for both tests (curves rising to 250° C.). In contrast, the temperature measurements on the two foils B1, B2 and on the accumulator A1 are significantly different. A drop in temperature of the order of 40° C. can be observed on the foils with the aqueous gel. The temperature is also lower for the accumulator A2 when aqueous gel has been added, which proves the mitigation effect thereof.

One of the indirect ways to limit the thermal runaway of a triggering accumulator A2 is that the thermal energy released is shared by the adjacent accumulators A1, A3, A4. This takes place without raising the temperature of the neighboring accumulators above a temperature of 120° C.

However, when the triggering accumulator is arranged on one edge of the module M, it can only exchange heat with a few neighboring accumulators, which considerably increases the risk that the latter also go into thermal runaway.

Thus, to avoid this, it is possible to locally increase the thickness of the gel layer on the most critical accumulators.

This embodiment variant is illustrated in FIG. 10, where a region of increased thickness 14 of the layer of aqueous gel can be seen.

Similarly, the electrical contact points between the accumulators and the busbars constitute preferential places for thermal diffusion during the abnormal heating of an accumulator. It is therefore advantageous to position regions of increased thickness of the gel layer directly above these points.

Likewise, the possible rupture of the overpressure vents of an accumulator, during a thermal runaway, causes the projection, out of the accumulator, of high-temperature gas along an outgassing path. The positioning of a region of increased thickness of the gel layer on the busbars close to each potential outgassing path makes it possible to absorb a portion of the heat released.

To produce localized regions of increased thickness, the aqueous gel can be 3D printed directly on the busbar, with screen printing for example with a viscosity of between 5 and 20 pa·s. These technologies make it possible, simply and with limited cost, to adapt the local thicknesses to the need for thermal protection.

The invention is not limited to the examples that have just been described; features of the illustrated examples may in particular be combined together within variants not illustrated.

Further variants and improvements may be envisaged without departing from the scope of the invention.

While, in the examples illustrated, the multilayer film 10 systematically comprises two encapsulation layers 12, 13 made of plastic, it is possible to provide a film with a single layer 13, the gel layer 11 being directly applied against a busbar.

In the examples illustrated, gel layer 11 is a continuous layer over the length of film 10. A discontinuous layer can very well be envisaged, with the presence of gel at the most critical locations, that is to say at the points facing zones where the hot gases would be released by the safety vents of the accumulators.

The examples given above relating to the positive pole of the accumulators are also transferable to the application on a busbar on the side of the negative poles.

In the embodiments illustrated, the accumulators are cylindrical, for example of the 18650 type, with a safety vent in the positive terminal of each accumulator. Other forms of accumulators and/or other arrangements of safety vents can be envisaged.

In order not to affect the exit of the gases via the safety vents of the accumulators, the encapsulation layer made of plastic 12 can be precut or else post-cut, for example by laser, in zones that are to be facing said vents. However, the pressures and temperatures at which the gases exit via the vents are such that the gelled barrier and the encapsulation layers according to the invention can be selected such as not to represent notable barriers to the evacuation of said gases, by providing a mechanical and thermal strength that is insufficient to oppose it.

### LIST OF CITED REFERENCES

[1] https://www.mersen.com/sites/default/files/publications-media/16-markets-transportation-ev-hev-emobility-presentation-mersen.pdf.
[2] Xuning Fenga, et al. “Key Characteristics for Thermal Runaway of Li-ion Batteries” Energy Procedia, 158 (2019) 4684-4689.

1. A multilayer film, configured to be applied in a battery module (M), the multilayer film comprising:
an encapsulation layer comprising plastic; and
an aqueous gel layer, configured to be placed on the path of one or more hot gases released by an accumulator of the module during a thermal runaway, encapsulated at least partially by the encapsulation layer.

2. The multilayer film of claim 1, wherein the aqueous gel layer is a continuous layer over the length of the film.

3. The multilayer film of claim 1, wherein the aqueous gel layer comprises a region of increased thickness over the length of the film.

4. The multilayer film of claim 1, wherein the gel layer is printed directly on the encapsulation layer.

5. The multilayer film of claim 1, comprising two encapsulation layers, one of which is configured to be applied directly against the busbar.

6. The multilayer film of claim 5, wherein the encapsulation layer configured to be applied directly against the busbar is adhesive on its external face.

7. The multilayer film of claim 1, comprising a single encapsulation layer,
wherein the aqueous gel layer is configured to be applied directly against the busbar.

8. The multilayer film of claim 1, wherein the polymer of the encapsulation layer is polyethylene or polyether.

9. The multilayer film of claim 1, wherein a thickness of each encapsulation layer is at most 50 μm.

10. The multilayer film of claim 1, wherein the aqueous gel layer comprises an aqueous gel comprises at least 90% deionized water and a gelation polymer having a high degree of polymerization.

11. The multilayer film of claim 10, wherein the gelation polymer comprises a methylcellulose, carboxymethylcellulose, polyurethane, galactan, or sodium polyacrylate.

12. The multilayer film of claim 1, wherein a thickness of the aqueous gel layer is at most 10 mm.

13. The multilayer film of claim 1, wherein the encapsulation layer is made of plastic, and is configured to face at least a portion of the busbar, and
wherein the encapsulation layer comprises rupture initiators precut into the encapsulation layer or cutouts leaving the gel layer exposed from outside of the multilayer film.

14. The multilayer film of claim 1, which is configured to enable passage of the one or more hot gases during release thereof and to form a thermal barrier between the one or more hot gases that have passed through and the accumulator of the module.

15. A battery module, comprising:
a plurality of accumulators of cylindrical geometry, each comprising an electrochemical cell C comprising a cathode, an anode, and an electrolyte interposed between the cathode and the anode, a casing designed to contain in a sealtight manner the electrochemical cell, and a first and second output terminal projecting from the cover and/or from the base of the casing;
the multilayer film of claim 1, wherein the aqueous gel layer is placed in at least one zone suitable for passage of the one or more hot gases released by one of the accumulators during a thermal runaway.

16. The battery module of claim 15, wherein the aqueous gel layer of the film comprises a region of increased thickness over the length of the multilayer film.

17. The battery module of claim 15, wherein the aqueous gel layer is printed directly on a busbar.

18. The battery module of claim 15, wherein each of the accumulators is an Li-ion accumulator comprising:
a negative electrode material comprising graphite, lithium, and/or titanate oxide Li₄TiO₅O₁₂; and
a positive electrode material comprising LiFePO₄, LiCoO₂, and/or LiNi_{0.33}Mn_{0.33}Co_{0.33}O₂.

19. The multilayer film of claim 1, wherein the encapsulation layer is configured to be placed facing at least a portion of the busbar, and/or
wherein the gel layer is a discontinuous layer over the length of the film.

20. The battery module of claim 15, further comprising
a busbar fastened to one of the output terminals of at least some of the accumulators, in order to electrically connect the at least some of the accumulators to one another.
